(19) United States
(12) Patent Application Publication
(10) Pub. No.: US 2011/0267943 A1
(43) Pub. Date: Nov. 3, 2011

(54) STATIC UU-UN BEARER MAPPING BASED ON QUALITY OF SERVICE

(75) Inventors: Xiaolong Huang, San Diego, CA (US); Fatih Ulupinar, San Diego, CA (US)

(73) Assignee: QUALCOMM Incorporated, San Diego, CA (US)

(21) Appl. No.: 13/096,653

(22) Filed: Apr. 28, 2011

Related U.S. Application Data
(63) Continuation of application No. 61/330,254, filed on Apr. 30, 2010.

(51) Int. Cl. H04W 72/08; H04W 24/02

(52) U.S. Cl. 370/230; 370/315

(57) ABSTRACT

Certain aspects of the present disclosure provide techniques and apparatuses for implementing a static mapping between a Uu radio bearer and a Un radio bearer based on quality of service (QoS) class identifier (QCI). According to certain aspects, a donor base station perform a Un bearer management procedure to establish a Un radio bearer that does not utilize TFT such that the QCI-based static Uu-Un bearer mapping does not interfere with existing traffic mappings that utilize Service Data Flow (SDF) filters. In addition, the QCI-based static Uu-Un bearer mapping can satisfy QoS requirement(s) for bearer handling without requiring modification to wireless protocols or associated specification(s) of telecommunication networks with relay nodes.

### CLAIM OF PRIORITY UNDER 35 U.S.C. §119

The present application for patent claims benefit of U.S. Provisional Patent Application Ser. No. 61/330,254, entitled, “Static Uu-Un Bearing Mapping in Part on Quality of Service Class Index (QCI),” filed Apr. 30, 2010 and assigned to the assignee hereof and hereby expressly incorporated by reference herein.

### BACKGROUND

1. Field

Certain aspects of the disclosure relate generally to wireless communications systems and, more particularly, to techniques for operating a relay in a telecommunications network.

2. Background

Wireless communication systems are widely deployed to provide various types of communication content such as voice, data, and so on. These systems may be multiple-access systems capable of supporting communication with multiple users by sharing the available system resources (e.g., bandwidth and transmit power). Examples of such multiple-access systems include code division multiple access (CDMA) systems, time division multiple access (TDMA) systems, frequency division multiple access (FDMA) systems, 3GPP Long Term Evolution (LTE) systems, and orthogonal frequency division multiple access (OFDMA) systems.

Generally, a wireless multiple-access communication system can simultaneously support communication for multiple wireless terminals. Each terminal communicates with one or more base stations via transmissions on the forward and reverse links. The forward link (or downlink) refers to the communication link from the base stations to the terminals, and the reverse link (or uplink) refers to the communication link from the terminals to the base stations. This communication link may be established via a single-in-single-out (SISO), multiple-in-single-out (MISO) or a multiple-in-multiple-out (MIMO) system.

To supplement conventional mobile phone network base stations, additional base stations may be deployed to provide more robust wireless coverage to mobile units. For example, wireless relay stations and small-coverage base stations (e.g., commonly referred to as access point base stations, Home Node Bs, femto access points, or femto cells) may be deployed for incremental capacity growth, richer user experience, and in-building coverage. Typically, such small-coverage base stations are connected to the Internet and the mobile operator's network via DSL router or cable modem. As these other types of base stations may be added to the conventional mobile phone network (e.g., the backhaul) in a different manner than conventional base stations (e.g., macro base stations), there is a need for effective techniques for managing these other types of base stations and their associated user equipment.

### SUMMARY

Certain aspects of the present disclosure provide a method for operating a base station. The method generally includes establishing a data radio bearer that interfaces with a relay in a manner that does not utilize traffic flow templates (TFTs) with the data radio bearer. The method further includes receiving a mapping of the data radio bearer to at least one user radio bearer that interfaces between the relay and a user equipment (UE), wherein the mapping is based on a quality of service class identifier (QCI) associated with the data radio bearer.

Certain aspects of the present disclosure provide a method for operating a relay. The method generally includes establishing a data radio bearer that interfaces with a base station, in a manner that does not utilize TFTs with the data radio bearer. The method further includes receiving a mapping of the data radio bearer to at least one user radio bearer that interfaces between the relay and a UE, wherein the mapping is based on a QCI associated with the data radio bearer.

Certain aspects of the present disclosure provide an apparatus for wireless communications. The apparatus generally includes a bearer management module configured to establish a data radio bearer that interfaces with a relay in a manner that does not utilize traffic flow templates (TFTs) with the data radio bearer. The apparatus further includes a receiver module configured to receive a mapping of the data radio bearer to at least one user radio bearer that interfaces between the relay and a user equipment (UE), wherein the mapping is based on a quality of service class identifier (QCI) associated with the data radio bearer.

Certain aspects of the present disclosure provide an apparatus for wireless communications. The apparatus generally includes a bearer management module configured to establish a data radio bearer that interfaces with a base station, in a manner that does not utilize traffic flow templates (TFTs) with the data radio bearer. The apparatus further includes a receiver module configured to receive a mapping of the data radio bearer to at least one user radio bearer that interfaces between the apparatus and at least one user equipment (UE), wherein the mapping is based on a quality of service class identifier (QCI) associated with the data radio bearer.

Certain aspects of the present disclosure provide an apparatus for wireless communications. The apparatus generally includes means for establishing a data radio bearer that interfaces with a relay in a manner that does not utilize traffic flow templates (TFTs) with the data radio bearer. The apparatus further includes means for receiving a mapping of the data radio bearer to at least one user radio bearer that interfaces between the relay and a user equipment (UE), wherein the mapping is based on a quality of service class identifier (QCI) associated with the data radio bearer.

Certain aspects of the present disclosure provide an apparatus for wireless communications. The apparatus generally includes means for establishing a data radio bearer that interfaces with a base station, in a manner that does not utilize traffic flow templates (TFTs) with the data radio bearer. The apparatus further includes means for receiving a mapping of the data radio bearer to at least one user radio bearer that interfaces between the apparatus and at least one user equipment (UE), wherein the mapping is based on a quality of service class identifier (QCI) associated with the data radio bearer.

Certain aspects of the present disclosure provide a computer-program product comprising a computer-readable medium having instructions stored thereon. The instructions are generally executable by one or more processors and are for establishing a data radio bearer that interfaces with a relay in a manner that does not utilize traffic flow templates (TFTs) with the data radio bearer. The instructions further are for receiving a mapping of the data radio bearer to at least one user radio bearer that interfaces between the relay and a user equipment (UE), wherein the mapping is based on a quality of service class identifier (QCI) associated with the data radio bearer.

Certain aspects of the present disclosure provide a computer-program product comprising a computer-readable medium having instructions stored thereon. The instructions are executable by one or more processors and are for establishing a data radio bearer that interfaces with a base station, in a manner that does not utilize traffic flow templates (TFTs) with the data radio bearer. The instructions are further for receiving a mapping of the data radio bearer to at least one user radio bearer that interfaces between a relay and at least one user equipment (UE), wherein the mapping is based on a quality of service class identifier (QCI) associated with the data radio bearer.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 illustrates a multiple access wireless communication system.

FIG. 2 is a block diagram of a wireless communication system.

FIG. 3 illustrates an exemplary wireless communication system having a relay.

FIG. 4 illustrates example modules of a wireless communication system capable of implementing techniques presented herein.

FIG. 5 illustrates an example of mapping between radio bearers in a wireless communication system according to certain aspects of the disclosure.

FIG. 6 illustrates example operations that may be performed by a base station to manage a Uu-Un radio bearer mapping according to certain aspects of the present disclosure.

FIG. 7 illustrates example operations that may be performed by a relay node to manage a Uu-Un radio bearer mapping according to certain aspects of the present disclosure.

FIG. 8 is a sequence diagram illustrating example operations for Un bearer management according to certain aspects of the present disclosure.

### DETAILED DESCRIPTION

Certain aspects of the present disclosure provide apparatuses and techniques for managing radio bearers in wireless communications having a relay node and donor base station. The relay node may be used to supplement and extend coverage in a given geographical area by providing service to a plurality of wireless terminals, or user equipment (UE). A radio bearer of an interface between a relay node and UE may be referred to as a user equipment radio bearer, a “Uu” radio bearer, or Uu bearer. A radio bearer of an interface between a relay node and an associated donor base station may be referred to as a base station radio bearer, “Un” radio bearer, or Un bearer. In some wireless networks having relays, the Uu radio bearers used for UE packet flows between a relay and its served UEs may be carried by the Un data radio bearers used for packet flows between the relay and its donor base station.

According to certain aspects multiple Uu bearers for UE traffic having a certain Quality of Service (QoS) Class Identifier (QCI) may be aggregated and served by a single Un bearer provided for relay traffic. According to certain aspects, mappings between the Uu bearer packets and Un bearer packets in the downlink direction may be administered at a relay's Serving/Packet Data Network Gateway (S/P GW), typically co-located at a donor base station. Mappings between Uu bearer packets and Un bearer packets in the uplink directions are administrated at the relay. According to certain aspects, the Uu-Un bearer mappings may be statically assigned based on the QCI values of the Uu and Un bearers. However, a relay node may have additional traffic to serve across other bearers. Therefore, there is a need for techniques that provide Uu-Un bearer mapping using QCI to serve the Uu bearer while serving other traffic generated by a relay node itself. Accordingly, certain aspects of the present disclosure provide techniques for managing static Uu-Un bearer mapping based on QCI that configure and set TFT (traffic flow template) such that the QCI-based Uu-Un bearer mapping may not interfere with additional traffic mapping provided by Service Data Flows (SDF) filters. According to certain aspects, a data radio bearer is established that interfaces with a relay in a manner that does not utilize traffic flow templates (TFTs) with the data radio bearer.

The techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), cdma2000, etc. UTRA includes Wideband-CDMA (W-CDMA) and Low Chip Rate (LCR). cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). Long Term Evolution (LTE) is a release of UMTS that uses E-UTRA. UTRA, E-UTRA, GSM, UMTS and LTE are described in documents from an organization named “3rd Generation Partnership Project” (3GPP). cdma2000 is described in documents from an organization named “3rd Generation Partnership Project 2” (3GPP2). These various radio technologies and standards are known in the art. For clarity, certain aspects of the techniques are described below for LTE, and LTE terminology is used in much of the description below.

Single carrier frequency division multiple access (SC-FDMA), which utilizes single carrier modulation and frequency domain equalization is a technique. SC-FDMA has similar performance and essentially the same overall complexity as those of OFDMA system. SC-FDMA signal has lower peak-to-average power ratio (PAPR) because of its inherent single carrier structure. SC-FDMA has drawn great attention, especially in the uplink communications where lower PAPR greatly benefits the mobile terminal in terms of transmit power efficiency. It is currently a working assumption for uplink multiple access scheme in 3GPP Long Term Evolution (LTE), or Evolved UTRA.

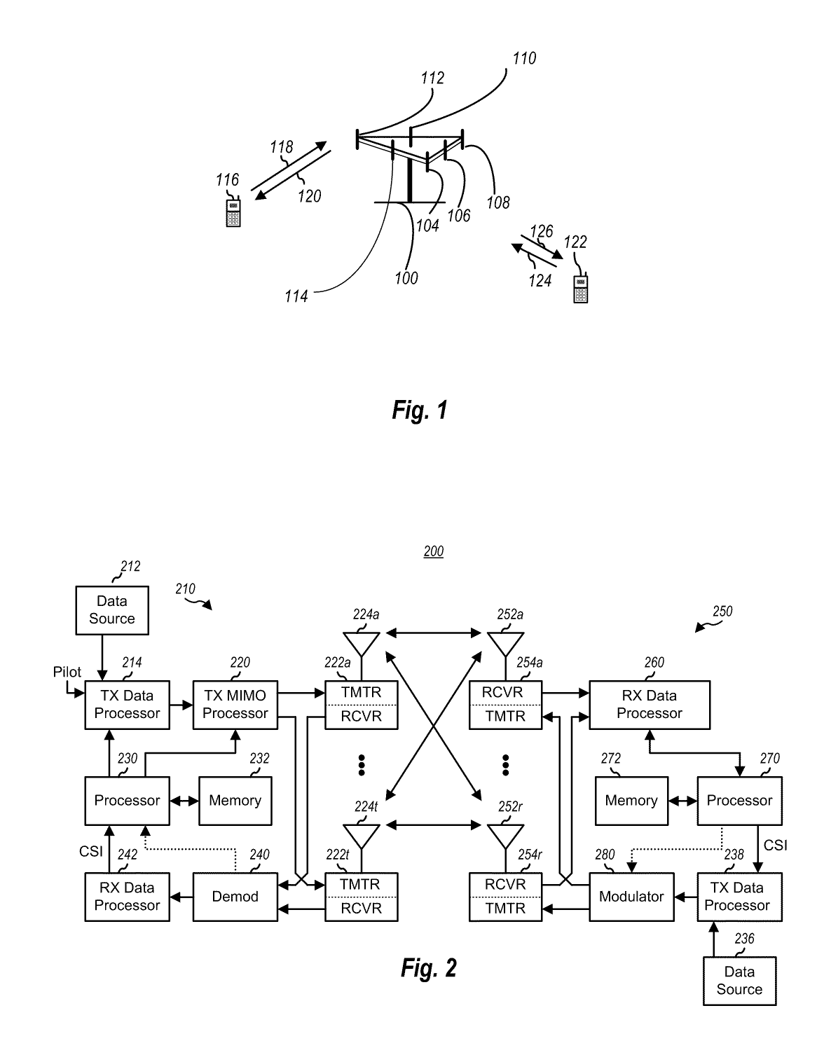

Referring to FIG. 1, a multiple access wireless communication system according to one aspect is illustrated. An access point 100 (AP) includes multiple antenna groups, one including antennas 104 and 106, another including antennas 108 and 110, and yet another including antennas 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 120 and receive information from access terminal 116 over reverse link 118. Access terminal 122 is in communication with antennas 106 and 108, where antennas 106 and 108 transmit information to access terminal 122 over forward link 126 and receive information from access terminal 122 over reverse link 124. In a FDD system, communication links 118, 120, 124 and 126 may use different frequency for communication. For example, forward link 120 may use a different frequency than that used by reverse link 118.

Each group of antennas and/or the area in which they are designed to communicate is often referred to as a sector of the access point. In the aspect shown in FIG. 1, each antenna group is designed to communicate to access terminals in a sector, of the areas covered by access point 100.

In communication over forward links 120 and 126, the transmitting antennas of access point 100 utilize beamforming in order to improve the signal-to-noise ratio (SNR) of forward links for the different access terminals 116 and 122. Also, an access point using beamforming to transmit to access terminals scattered randomly through its coverage causes less interference to access terminals in neighboring cells than an access point transmitting through a single antenna to all its access terminals.

According to certain aspects, an AT 116 may be in communication with an AP 100 by means of a radio interface, such as a Uu interface. Further, additional APs 100 may be inter-connected with each other by means of an interface known as X2, and to a network node, such as an Enhanced Packet Core (EPC) node, by means of an Si interface.

An access point may be a fixed station used for communicating with the terminals and may also be referred to as a base station, a Node B, an evolved Node B (eNB), an eNodeB, or some other terminology. An access terminal may also be called a mobile station (MS), user equipment (UE), a wireless communication device, wireless terminal, or some other terminology.

FIG. 2 is a block diagram of an aspect of a transmitter system 210 (also known as the access point) and a receiver system 250 (also known as the access terminal) in a MIMO system 200. At the transmitter system 210, traffic data for a number of data streams is provided from a data source 212 to a transmit (TX) data processor 214.

In an aspect, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain aspects, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from NR receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

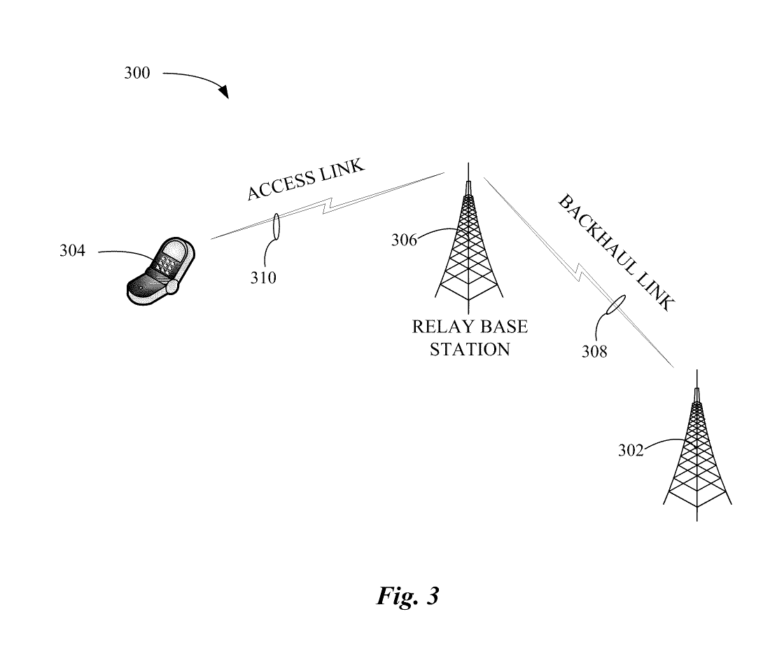

According to certain aspects of the present disclosure, the transmitter system 210 includes additional components for operating in a wireless communications network having a relay node, as described herein. Specifically, the transmitter system 210 may be configured as a donor base station as shown in FIG. 3. According to certain aspects, the transmitter system 210 may be configured to establish a radio connection that interfaces with a relay node and that includes at least one data radio bearer configured to not utilize TFTs, as described further below. According to certain aspects, the transmitter system 210 may further be configured to manage a mapping of the data radio bearer to at least one Uu radio bearer based on the QCI associated with the data radio bearer from a downlink direction.

According to certain aspects, logical channels are classified into Control Channels and Traffic Channels. Logical Control Channels comprise a Broadcast Control Channel (BCCH) which is a DL channel for broadcasting system control information, a Paging Control Channel (PCCH) which is a DL channel that transfers paging information, and a Multicast Control Channel (MCCH) which is a point-to-multipoint DL channel used for transmitting Multimedia Broadcast and Multicast Service (MBMS) scheduling and control information for one or several MTCHs. Generally, after establishing an RRC connection, this channel is only used by UEs that receive MBMS (Note: old MCCH+MSCH). Dedicated Control Channel (DCCH) is a point-to-point bi-directional channel that transmits dedicated control information and used by UEs having an RRC connection. In an aspect, Logical Traffic Channels comprise a Dedicated Traffic Channel (DTCH) which is a point-to-point bi-directional channel, dedicated to one UE, for the transfer of user information. Also, a Multicast Traffic Channel (MTCH) is a point-to-multipoint DL channel for transmitting traffic data.

According to certain aspects, Transport Channels are classified into DL and UL. DL Transport Channels comprise a Broadcast Channel (BCH), a Downlink Shared Data Channel (DL-SDCH) and a Paging Channel (PCH), the PCH for support of UE power saving (DRX cycle is indicated by the network to the UE), broadcasted over entire cell and mapped to PHY resources which can be used for other control/traffic channels. The UL Transport Channels comprise a Random Access Channel (RACH), a Request Channel (REQCH), an Uplink Shared Data Channel (UL-SDCH), and a plurality of PHY channels. The PHY channels comprise a set of DL channels and UL channels.

The DL PHY channels comprise:

Common Pilot Channel (CPICH)

Synchronization Channel (SCH)

Common Control Channel (CCCH)

Shared DL Control Channel (SDCCH)

Multicast Control Channel (MCCH)

Shared UL Assignment Channel (SUACH)

Acknowledgement Channel (ACKCH)

DL Physical Shared Data Channel (DL-PSDCH)

UL Power Control Channel (UPCCH)

Paging Indicator Channel (PICH)

Load Indicator Channel (LICH)

The UL PHY Channels comprise:

Physical Random Access Channel (PRACH)

Channel Quality Indicator Channel (CQICH)

Acknowledgement Channel (ACKCH)

Antenna Subset Indicator Channel (ASICH)

Shared Request Channel (SREQCH)

UL Physical Shared Data Channel (UL-PSDCH)

Broadband Pilot Channel (BPICH)

For the purposes of the present document, the following abbreviations apply:

ACK Acknowledgement

AM Acknowledged Mode

AMD Acknowledged Mode Data

ARQ Automatic Repeat Request

BCCH Broadcast Control CHannel

BCH Broadcast CHannel

BW Bandwidth

C- Control-

CB Contention-Based

CCE Control Channel Element

CCCH Common Control CHannel

CCH Control CHannel

CCTrCH Coded Composite Transport Channel

CDM Code Division Multiplexing

CF Contention-Free

CP Cyclic Prefix

CQI Channel Quality Indicator

CRC Cyclic Redundancy Check

CRS Common Reference Signal

CTCH Common Traffic CHannel

DCCH Dedicated Control CHannel

DCH Dedicated CHannel

DCI Downlink Control Information

DL DownLink

DRS Dedicated Reference Signal

DSCH Downlink Shared Channel

DSP Digital Signal Processor

DTCH Dedicated Traffic CHannel

E-CID Enhanced Cell IDentification

EPS Evolved Packet System

FACH Forward link Access CHannel

FDD Frequency Division Duplex

FDM Frequency Division Multiplexing

FSTD Frequency Switched Transmit Diversity

HARQ Hybrid Automatic Repeat/request

HW Hardware

IC Interference Cancellation

L1 Layer 1 (physical layer)

L2 Layer 2 (data link layer)

L3 Layer 3 (network layer)

LI Length Indicator

LLR Log-Likelihood Ratio

LSB Least Significant Bit

MAC Medium Access Control

MBMS Multimedia Broadcast Multicast Service

MCCH MBMS point-to-multipoint Control Channel

MMSE Minimum Mean Squared Error

MRW Move Receiving Window

MSB Most Significant Bit

MSCH MBMS point-to-multipoint Scheduling CHannel

MTCH MBMS point-to-multipoint Traffic CHannel

NACK Non-Acknowledgement

PA Power Amplifier

PBCH Physical Broadcast CHannel

PCCH Paging Control CHannel

PCH Paging CHannel

PCI Physical Cell Identifier

PDCCH Physical Downlink Control CHannel

PDU Protocol Data Unit

PHICH Physical HARQ Indicator CHannel

PHY PHYsical layer

PhyCH Physical CHannels

PMI Precoding Matrix Indicator

PRACH Physical Random Access Channel

PSS Primary Synchronization Signal

PUCCH Physical Uplink Control CHannel

PUSCH Physical Uplink Shared CHannel

QoS Quality of Service

RACH Random Access CHannel

RB Resource Block

### RLC Radio Link Control

RRC Radio Resource Control

RE Resource Element

RI Rank Indicator

RNTI Radio Network Temporary Identifier

RS Reference Signal

RTT Round Trip Time

Rx Receive

SAP Service Access Point

SDU Service Data Unit

SFBC Space Frequency Block Code

SHCCH SHared channel Control CHannel

SINR Signal-to-Interference-and-Noise Ratio

SN Sequence Number

SR Scheduling Request

SRS Sounding Reference Signal

SSS Secondary Synchronization Signal

SU-MIMO Single User Multiple Input Multiple Output

SUFI SUper Field

SW Software

TA Timing Advance

TCH Traffic CHannel

TDD Time Division Duplex

TDM Time Division Multiplexing

TFI Transport Format Indicator

TPC Transmit Power Control

TTI Transmission Time Interval

Tx Transmit

U- User-

UE User Equipment

UL UpLink

UM Unacknowledged Mode

UMD Unacknowledged Mode Data

UMTS Universal Mobile Telecommunications System

UTRA UMTS Terrestrial Radio Access

UTRAN UMTS Terrestrial Radio Access Network

VoIP Voice Over Internet Protocol

MBSFN multicast broadcast single frequency network

MCH multicast channel

DL-SCH downlink shared channel

PDCCH physical downlink control channel

PDSCH physical downlink shared channel

### Static Uu-Un bearer mapping based on Quality of Service Class Identifier (QCI)

As described above, wireless communication systems may comprise a relay node associated with a donor base station to provide service to wireless terminals. The relay base station may communicate with the donor base station via a backhaul link, sometimes referred to as a “Un interface”, and with the terminals via an access link, sometimes referred to as a “Uu interface.”

FIG. 3 illustrates an example wireless system 300 in which certain aspects of the present disclosure may be practiced. As illustrated, the system 300 includes a donor base station (also known as a donor access point (AP), a donor BS, a donor eNodeB, or DeNB) 302 that communicates with a UE 304 via a relay node (also known as relay access point or relay base station) 306. The relay BS 306 may communicate with the donor BS 302 via a backhaul link 308 and with the UE 304 via an access link 310.

In other words, the relay BS 306 may receive downlink messages from the donor BS 302 over the backhaul link 308 and relay these messages to the UE 304 over the access link 310. Similarly, the relay BS 306 may receive uplink messages from the UE 304 over the access link 310 and relay these messages to the donor BS 302 over the backhaul link 308. The relay BS 306 may, thus, be used to supplement a coverage area and help fill “coverage holes.”

According to certain aspects, the relay BS 306 may communicate with the UE 304 (i.e., relay downlink messages to the UE and receive uplink messages from the UE) utilizing at least a Uu radio bearer on the access link 310 connecting the relay BS 306 and UE 304. According to certain aspects, the relay BS 306 may communicate with the donor BS 302 utilizing a Un radio bearer connecting the relay BS 306 and donor BS 302 on the backhaul link 308.

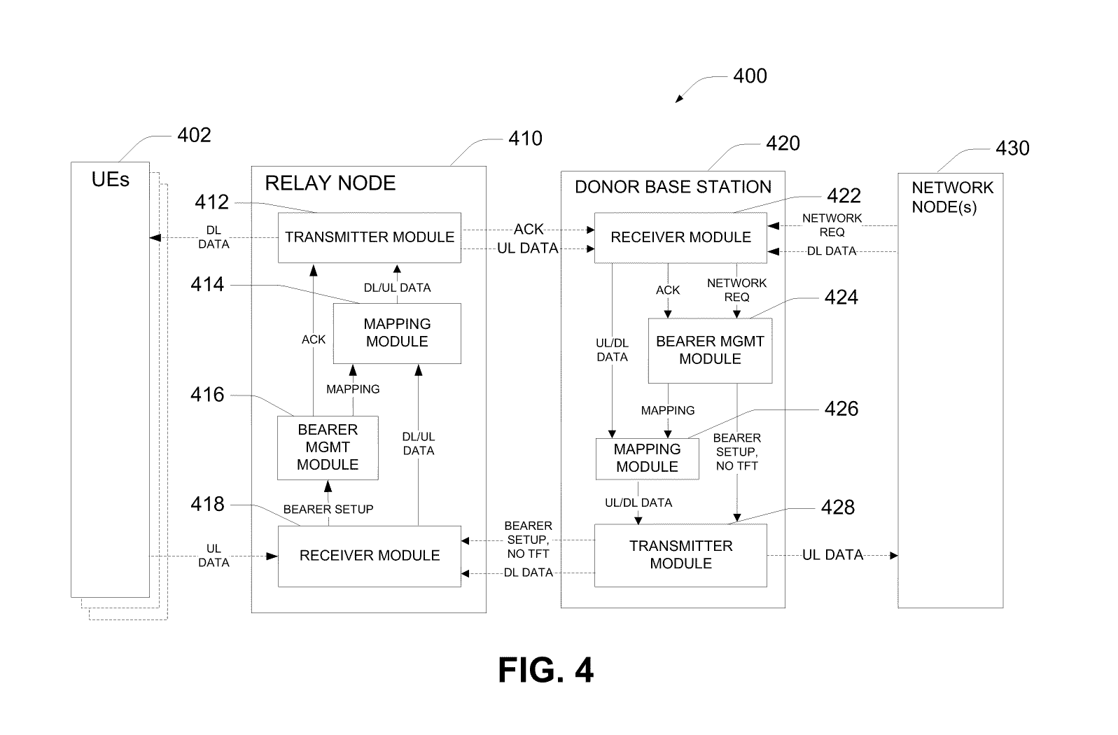

FIG. 4 illustrates an example wireless system 400 capable of performing techniques described herein for managing a static Uu-Un bearer mapping based on QCI. As illustrated, the wireless system 400 represents a wireless telecommunications network having a plurality of UEs 402, a relay node 410, a donor base station 420, at least one network node(s) 430. According to certain aspects, the network node(s) 430 represent one or more network components part of an Evolved Packet Core (EPC) network, such as a Mobility Management Entity (MME) or Serving/PDN Gateway (S-P GW) for at least one of the plurality of UEs 402 or a MME for the relay node 410. According to certain aspects, one or more modules of the donor base station 420 may be utilized as an S/P GW module for the relay node 410, wherein the S/P GW module is collocated with the donor base station 420.

As illustrated, the donor base station 420 may include a receiver module 422 configured to receive one or more network requests from one or more network node(s) 430. The network request may be one or more messages from the network node (s) for establishing a data radio bearer between the donor base station 420 and relay node 410. According to certain aspects, the receiver module 422 may receive a network request comprising a bearer setup request, or a session-management request, from a MME or S/P GW of one of one of the plurality of UEs 402. According to certain aspects, the receiver module 422 may receive a network request comprising a bearer setup request from a MME of the relay node 410 indicating a Quality of Service value to be associated with the data radio bearer. According to certain aspects, the receiver module 422 may be configured to receive a network request comprising a mapping of the data radio bearer to least one Uu radio bearer that interfaces between the relay node 410 and at least one of the plurality of UEs 402. The mapping may be based on the QCI associated with the data radio bearer and the QCI values associated with the Uu radio bearer.

As illustrated, the receiver module 422 provides the network request to a bearer management module 424 configured to process the network request. As illustrated, the receiver module 422 retrieves a Uu-Un bearer mapping from the processed network request and provides the mapping to a mapping module 426 configured to map communications to the relay node 410 to a corresponding bearer. Additionally, as illustrated, the bearer management module 424 generates a bearer setup message based on the network request to establish a data radio bearer that interfaces with the relay node 410 in a manner that does not utilize TFTs with the data radio bearer. The bearer management module 424 provides the bearer setup message to the transmitter module 428 for transmission to the relay node 410.

As illustrated, the relay node 410 may include a receiver module 418 configured to receive the bearer setup message from the donor base station 420. The receiver module 418 may provide the bearer setup message to a bearer management module 416 configured to process the bearer setup message to establish a data radio bearer that interfaces with the donor base station 420. As illustrated, the bearer management module 416 processes the bearer setup message to determine a Uu-Un bearer mapping and provides the bearer mapping to a mapping module 414 configured to map uplink transmissions to a corresponding radio bearer. Additionally, the bearer management module 416 may optionally generate an acknowledgment message indicating radio connection reconfiguration. The bearer management module 416 provides the acknowledgment message to a transmitter module 412 for transmission to the donor base station 420. As illustrated, the receiver module 422 at the donor base station 420 may receive the acknowledgment message and provide an indication to the bearer management module 424 that the bearer setup message was successfully received by the relay node 410 and that the data radio bearer has been successfully established.

According to certain aspects, once a Un bearer has been established as described above, the wireless system 400 may be operated to relay uplink and downlink transmissions. As illustrated, the receiver module 422 of the donor base station 420 receives one or more downlink data packets from the network node(s) 430, wherein the downlink data packets may represent data traffic from services provided by the network node(s). The receiver module 422 provides the downlink data packets to the mapping module 426 to map the downlink packets onto a Un data radio bearer based on the Uu-Un bearer mapping described above. According to certain aspects, the mapping module 426 may determine whether a SDF filter applies to at least one of the downlink packet. Responsive to determining an SDF filter does not apply, the mapping module 426 may utilize a mapping to map the downlink data packet to a data radio bearer and provide the downlink data packet to the transmitter module 428 for transmission to the relay node 410.

Similarly, the receiver module 418 receives one or more uplink data packets from the UEs 402 for uplink transmission. As illustrated, the receiver module 418 provides the uplink data packets to the mapping module 414, which is configured to map the uplink data packets to Un data radio bearers based on the Uu-Un data mapping. As illustrated, the mapping module maps the uplink data packets to a corresponding Un radio bearer and provides the uplink data packets to the transmitter module 412 for transmission to the donor base station 420.

According to certain aspects, when the relay node has activated a Un data radio bearer based on a reconfiguration message having a TFT specified as “No TFT Operation”, the mapping module 414 of the relay node may only use the QCI value of uplink packets for mapping the uplink packets into the particular Un data radio bearer. According to certain aspects, when the mapping module 414 maps an uplink packet to a Un data radio bearer, the mapping module 414 may first apply SDF filters before use of the QCI-based static Uu-Un bearer mapping. Accordingly, the other data radio bearers of the relay that use explicit SDF filters may still function correctly alongside the static Uu-Un bearer mapping. For example, since the relay node may have other data radio bearers established exclusively for signaling with the network nodes 430, such as Operation, Administration, and Maintenance (OA&M) messages, the relay node may serve the Uu bearer traffic while continuing to serve the other traffic generated by the relay node itself.

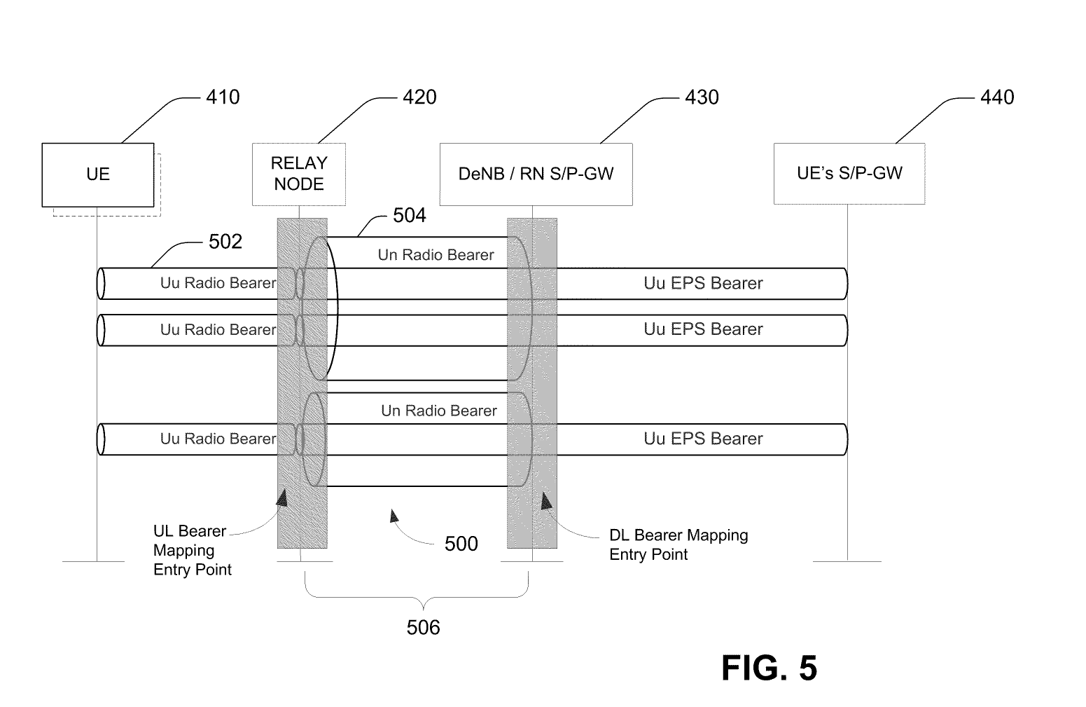

FIG. 5 illustrates an example of a mapping 500 between Uu bearers 502 and Un bearers 504 statically specified based on a QCI value of the bearers utilized in the wireless system 400, according to certain aspects of the present disclosure. A plurality of Uu radio bearers 502 provides data flow between a UE 402 and the relay node 410. As illustrated, the plurality of Uu radio bearers 502 are mapped to a single Un radio bearer 504 in the interface 506 between the relay node 410 and a donor base station 420. The mapped Uu radio bearers 402 represent data packet flow from the UEs 402 to the UE's S/P-GW 430 on Uu Evolved Packet System (EPS) bearers.

According to certain aspects, a many-to-one mapping 500 may be provided between the Uu bearers 502 and the Un bearers 504 that maps Uu bearers 502 having a certain QCI value to a same Un bearer 504 having a certain QCI value designated for carrying the Uu bearers with the particular QCI values, to maintain QoS treatment for the individual Uu bearers 502. For example, the mapping 500 may map Uu bearers 502 with a particular QCI to a Un bearer 504 having the same QCI value. It is understood that, according to certain aspects, the mapping 500 may map Uu bearers 502 having different QCI values to a Un bearer 504 having a QCI designated for carrying packets of the Uu bearers 502. As illustrated, a Un bearer may also be mapped to only a single Uu bearer.

As illustrated, the donor base station 420 provides a downlink bearer mapping entry point by administering the mapping between packets on the Uu bearers 502 and packets on Un bearers 504 in the downlink direction at the relay node's S/P-GW, typically co-located at the donor base station 420. As illustrated, the relay node 410 provides an uplink bearer mapping entry by administering the mapping between Uu bearer packets and Un bearer packets in the uplink direction.

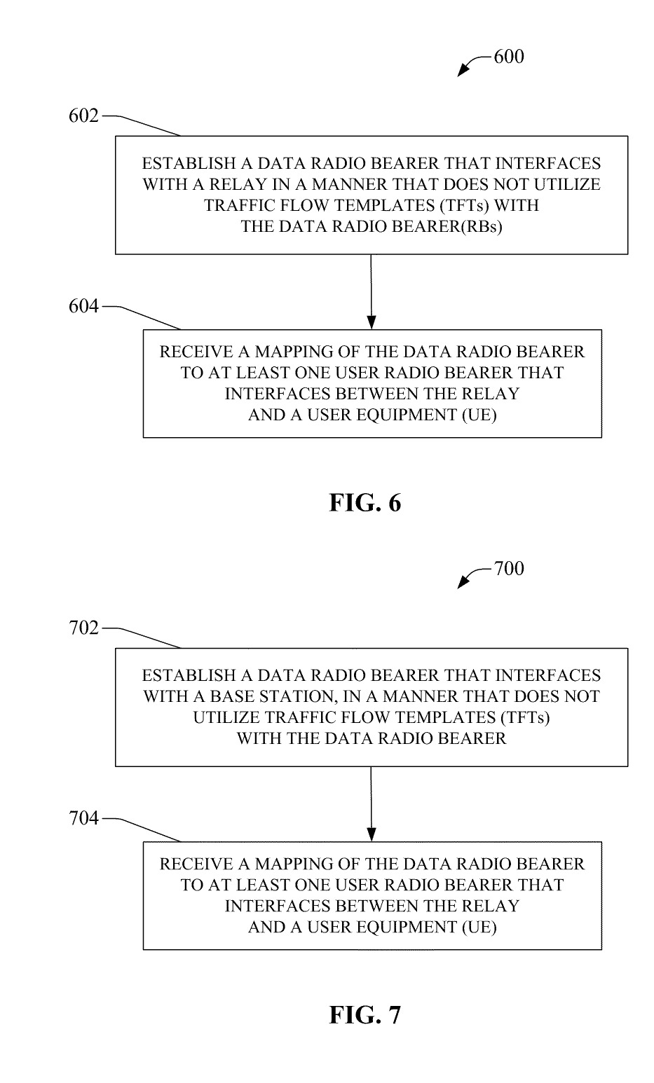

FIG. 6 illustrates an example operation 600 for operating a base station, according to certain aspects of the present disclosure. The example operation 600 begins at 602 where a base station establishes a data radio bearer that interfaces with a relay in a manner that does not utilize TFTs with the data radio bearer.

According to certain aspects, to establish a data radio bearer, the base station may transmit, to the relay's MME, a create bearer request comprising an indication to not utilize TFTs for the data radio bearer. According to certain aspects, the base station may further receive, from the relay's MME, a bearer setup request comprising a QCI to be associated with the data radio bearer. The base station may transmit, to the relay, a radio resource reconfiguration message comprising the indication of the QCI and an indication to not utilize TFT for the data radio bearer. For example, the base station may transmit an RRC Connection Reconfiguration message having a QCI value designated for carrying the at least one Uu radio bearer and having a TFT message with an operation code value corresponding to “No TFT Operation.”

At 604, the base station receives a mapping of the data radio bearer to at least one Uu radio bearer that interfaces between the relay and a UE. The mapping may be based on a QCI value associated with the data radio bearer. According to certain aspects, the mapping may be statically specified based on the QCI of the Uu radio bearers.

FIG. 7 illustrates an example operation 700 for operating a relay node, according to certain aspects of the present disclosure. The example operation 700 begins at 702 where a relay establishes a data radio bearer that interfaces with a relay in a manner that does not utilize TFTs with the data radio bearer. According to certain aspects, the relay node may receive a radio resource reconfiguration message comprising a QCI to be associated with the data radio bearer and an indication to not utilize TFTs for the data radio bearer. According to certain aspects, the indication may comprise a TFT having an operation code value corresponding to “No TFT Operation”.

At 704, the relay node may receive a mapping of the data radio bearer to at least one Uu radio bearer that interfaces between the relay and at least one UE. The mapping may be based on a QCI associated with the data radio bearer. According to certain aspects, the relay may receive at least uplink data packet to be transmitted to the base station via the Un radio bearer. According to certain aspects, the relay node first determines whether a SDF filter applies to the at least one uplink data packet, and responsive to determining no SDF filter applies, utilizes the mapping to map the uplink data packet to the data radio bearer.

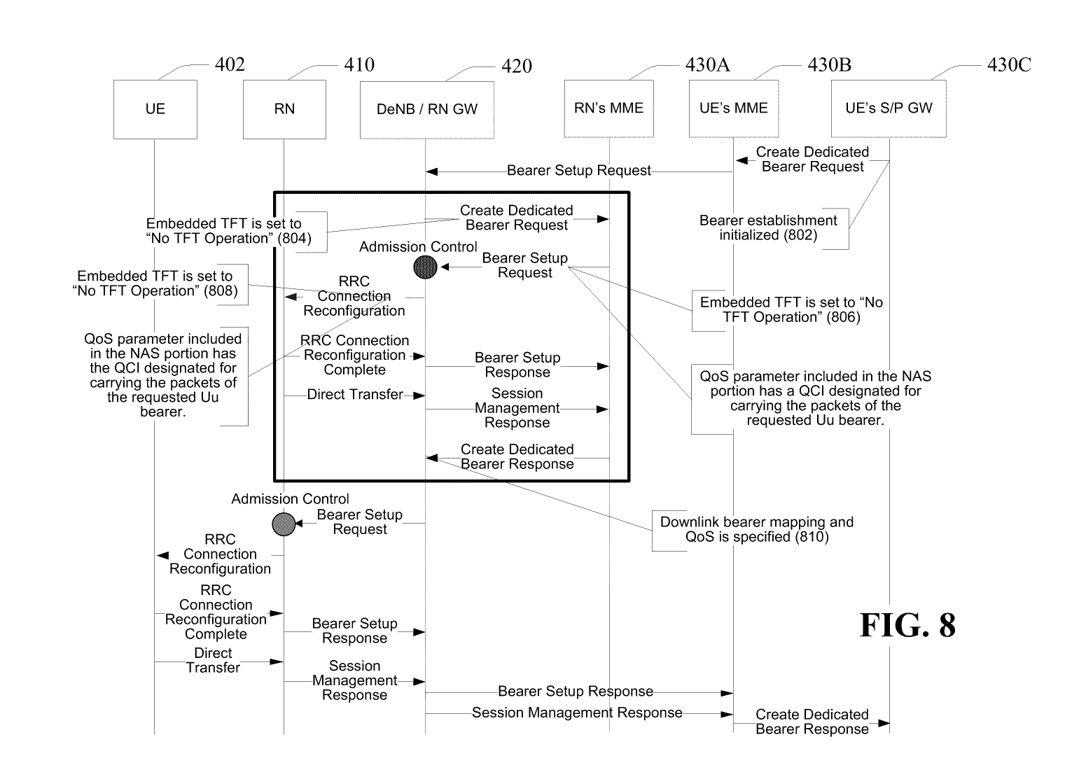

FIG. 8 is a sequence diagram illustrating example operations for Un radio bearer management according to certain aspects of the disclosure. As described above, certain aspects of the present disclosure provide a Un bearer mapping procedure that provides static Uu-Un bearer mapping based on QCI and in a manner that does not utilize TFTs so that the Uu-Un bearer mapping does not interfere with other traffic mapping utilizing SDF filters. For clarity, the example operations are depicted as being performed by the example system shown in FIG. 4, but it is understood that the procedure described below may be performed by other suitable apparatuses and components configured according to certain aspects of the disclosure.

The example operations begin at 802, where Un bearer establishment is initialized to establish a data radio bearer that interfaces between a donor base station 420 and a relay node 410 connected to at least one UE 402. As illustrated, an S/P-Gateway 430C of the UE may transmit a Create Dedicated Bearer Request message to a MME 430B associated with the UE, which then transmits a Bearer Setup Request message to an S/P-Gateway associated with the relay node, depicted as being collocated with the donor base station.

As illustrated, at 804, responsive to the Bearer Setup Request message, the donor base station and relay node S/P-Gateway may generate a Create Dedicated Bearer Request to transmit to a MME 440A associated with the relay node. According to certain aspects, the donor base station may signal to the relay node's MME to create a dedicated radio bearer that does not utilize TFTs with the radio bearer. In other words, the donor base station may generate a Create Dedicated Bearer Request that does not include any functional TFT. Specifically, the Create Dedicated Bearer Request at 804 may comprise an embedded TFT specified as “No TFT Operation”. Upon receiving the Create Dedicated Bearer Request, the relay node's MME may process the request and approve activation of a Un data radio bearer using conventional MME bearer handling procedures.

At 806, once the Un bearer activation has been approved, the relay node's MME transmits a bearer setup request to the donor base station to authorize setup of the radio bearer at the donor base station. According to certain aspects, the relay node's MME may also transmit a Non-Access Stratum (NAS) message comprising a Session Management Request having an embedded TFT indicating “No TFT Operation”. The NAS message may also include a QoS parameter for the Un data radio bearer indicating a QCI value designated by the relay node's MME for carrying data packets of a particular Uu bearer. Upon receiving the Bearer Setup Request, the donor base station may perform conventional admission control procedures for establishing a Un bearer connection.

At 808, the donor base station performs a radio resource reconfiguration with the relay node to establish the Un radio bearer. As illustrated, the donor base station transmits a Radio Resource Control (RRC) Connection Reconfiguration message to the relay node. According to certain aspects, the RRC Connection Reconfiguration message includes an embedded TFT code value set to “No TFT Operation” and the QoS parameter received from the relay node's MME.

As illustrated, responsive to the RRC Connection Reconfiguration message, the relay node transmits a RRC Connection Reconfiguration Complete message to the donor base station indicating the radio connection between the donor base station and the relay has been successfully reconfigured. As illustrated, the donor base station acknowledges the Un bearer activation to the relay node's MME with a Bearer Setup Response and a Session Management Response.

At 810, as illustrated, the relay node's MME acknowledges the Un bearer activation by transmitting a Create Dedicated Bearer Response message to the donor base station. According to certain aspects, the relay node's MME may determine a downlink, static Uu-Un bearer mapping to map Uu bearers and Un bearers according to the bearers associated QoS/QCI values. As illustrated, the relay node's MME transmits the downlink bearer mapping and a specified QoS parameter to the donor base station. The donor base station may utilize the downlink bearer mapping to map downlink data packets for particular Uu bearers onto the now-established data radio bearer.

Subsequently, as illustrated, the donor base station may perform a similar radio bearer activation with the relay node to establish a Uu bearer that interfaces between the relay and the UE. For example, the donor base station transmits a Bearer Setup Request to the relay node to establish the Un bearer in the uplink direction. As illustrated, the relay node and the UE transmit RRC Connection Reconfiguration messages to modify the Uu bearer that interfaces the relay node and UE according to the configurations described above. As illustrated, the relay node may transmit a Bearer Setup Response and NAS Session Management Response to the donor base station to acknowledge the Uu bearer has been successfully reconfigured to support a static Uu-Un bearer mapping. Similarly, as illustrated, the donor base station may transmit a Bearer Setup response and Session Management Response to the UE's MME to acknowledge the Uu and Un bearers have been successfully set up and configured to support the static Uu-Un bearer mapping. Finally, the UE's MME may transmit a Create Dedicated Bearer Response to the UE's S/P-GW to signal the procedure has been completed according to certain aspects of the present disclosure. At this point, the Un bearer is deemed operational and may be utilized by the relay node and donor base station for uplink and downlink wireless communications.

It has been proposed to specify a generic Uu-Un bearer mapping at a relay node by dynamically installing DF filters at the relay node. However, the dynamic Uu-Un bearer mapping method may require changes to existing protocols and networks. Accordingly, certain aspects of the present disclosure provide a QCI-based static Uu-Un bearer mapping that may fully satisfy QoS requirements of bearer handling. Additionally, the Un bearer management procedure described herein advantageously utilizes only operational changes to network components and does not require specification or protocol changes, which may be prohibitively costly to implement throughout a network.

It is understood that the specific order or hierarchy of steps in the processes disclosed is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The various operations of methods described above may be performed by any suitable means capable of performing the corresponding functions. The means may include various hardware and/or software component(s) and/or module(s), including, but not limited to a circuit, an application specific integrated circuit (ASIC), or processor. For example, means for transmitting may comprise a transmitter, such as the transmitter unit 254 of the receiver system 250 (e.g., the access terminal) depicted in FIG. 2 or the transmitter unit 222 of the transmitter system 210 (e.g., the access point) shown in FIG. 2. Means for receiving may comprise a receiver, such as the receiver unit 254 of the receiver system 250 depicted in FIG. 2 or the receiver unit 222 of the transmitter system 210 shown in FIG. 2. Means for establishing, means for determining, and/or means for utilizing may comprise a processing system, which may include one or more processors, such as the processor 270 of the receiver system 250 or the processor 230 of the transmitter system 210 illustrated in FIG. 2. These means may also comprise any suitable combination of the transmitter modules 412, 428, the receiver modules 418, 422, the mapping modules 414, 426, and the bearer management modules 416, 424 of FIG. 4.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an ASIC, a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the spirit or scope of the disclosure. Thus, the present disclosure is not intended to be limited to the aspects shown herein but is to be accorded the widest scope consistent with the principles and novel features disclosed herein.

What is claimed is:

1. A method for operating a base station, comprising:
establishing a data radio bearer that interfaces with a relay in a manner that does not utilize traffic flow templates (TFTs) with the data radio bearer; and
receiving a mapping of the data radio bearer to at least one user radio bearer that interfaces between the relay and a user equipment (UE), wherein the mapping is based on a quality of service class identifier (QCI) associated with the data radio bearer.

2. The method of claim 1, wherein the establishing comprises:
transmitting, to a relay mobility management entity, a create bearer request comprising an indication to not utilize TFTs for the data radio bearer.

3. The method of claim 2, wherein the establishing further comprises:
receiving a bearer setup request comprising the QCI to be associated with the data radio bearer; and
transmitting, to the relay, a radio resource reconfiguration message comprising the QCI and the indication to not utilize TFT.

4. The method of claim 2, wherein the indication comprises a TFT having an operation code value corresponding to “No TFT Operation”.

5. The method of claim 1, wherein the QCI of the data radio bearer is designated for carrying the at least one user radio bearer.

6. The method of claim 1, further comprising:
receiving at least one downlink packet to forward to the relay;
determining whether a service data flow (SDF) filter applies to the at least one downlink packet; and
responsive to determining the SDF filter does not apply, utilizing the mapping to map the at least one downlink packet to the data radio bearer.

7. A method for operating a relay, comprising:
establishing a data radio bearer that interfaces with a base station, in a manner that does not utilize traffic flow templates (TFTs) with the data radio bearer; and
receiving a mapping of the data radio bearer to at least one user radio bearer that interfaces between the relay and at least one user equipment (UE), wherein the mapping is based on a quality of service class identifier (QCI) associated with the data radio bearer.

8. The method of claim 7, wherein the establishing comprises:
receiving a radio resource reconfiguration message comprising the QCI to be associated with the data radio bearer and an indication to not utilize TFTs for the data radio bearer.

9. The method of claim 8, wherein the indication comprises a TFT having an operation code value corresponding to “No TFT Operation”.

10. The method of claim 7, wherein the QCI of the data radio bearer is designated for carrying the at least one user radio bearer.

11. The method of claim 7, further comprising:
receiving at least one uplink packet to forward to the base station;
determining whether a service data flow (SDF) filter applies to the at least one uplink packet; and
responsive to determining the SDF filter does not apply, utilizing the mapping to map the at least one uplink packet to the data radio bearer.

12. An apparatus for wireless communications, comprising:
a bearer management module configured to establish a data radio bearer that interfaces with a relay in a manner that does not utilize traffic flow templates (TFTs) with the data radio bearer; and
a receiver module configured to receive a mapping of the data radio bearer to at least one user radio bearer that interfaces between the relay and a user equipment (UE), wherein the mapping is based on a quality of service class identifier (QCI) associated with the data radio bearer.

13. The apparatus of claim 12, further comprising:
a transmitter module configured to transmit, to a relay mobility management entity, a create bearer request comprising an indication to not utilize TFTs for the data radio bearer.

14. The apparatus of claim 13, wherein the receiver module is further configured to receive a bearer setup request comprising the QCI to be associated with the data radio bearer; and
wherein the transmitter module is further configured to transmit, to the relay, a radio resource reconfiguration message comprising the QCI and the indication to not utilize TFT.

15. The apparatus of claim 13, wherein the indication comprises a TFT having an operation code value corresponding to “No TFT Operation”.

16. The apparatus of claim 12, wherein the QCI of the data radio bearer is designated for carrying the at least one user radio bearer.

17. The apparatus of claim 12, wherein the receiver module is further configured to receive at least one downlink packet to forward to the relay; and wherein the apparatus further comprises:
a mapping module configured to determine whether a service data flow (SDF) filter applies to the at least one downlink packet, and responsive to determining the SDF filter does not apply, utilize the mapping to map the at least one downlink packet to the data radio bearer.

18. An apparatus for wireless communications, comprising:
a bearer management module configured to establish a data radio bearer that interfaces with a base station, in a manner that does not utilize traffic flow templates (TFTs) with the data radio bearer; and
a receiver module configured to receive a mapping of the data radio bearer to at least one user radio bearer that interfaces between the apparatus and at least one user equipment (UE), wherein the mapping is based on a quality of service class identifier (QCI) associated with the data radio bearer.

19. The apparatus of claim 18, wherein the establishing comprises:
receiving a radio resource reconfiguration message comprising the QCI to be associated with the data radio bearer and an indication to not utilize TFTs for the data radio bearer.

20. The apparatus of claim 19, wherein the indication comprises a TFT having an operation code value corresponding to “No TFT Operation”.

21. The apparatus of claim 18, wherein the QCI of the data radio bearer is designated for carrying the at least one user radio bearer.

22. The apparatus of claim 18, wherein the receiver module is further configured to receive at least one uplink packet to forward to the base station; and wherein the apparatus further comprises:
a mapping module configured to determine whether a service data flow (SDF) filter applies to the at least one uplink packet, and responsive to determining the SDF filter does not apply, utilize the mapping to map the at least one uplink packet to the data radio bearer.

23. An apparatus for wireless communications, comprising:
means for establishing a data radio bearer that interfaces with a relay in a manner that does not utilize traffic flow templates (TFTs) with the data radio bearer; and
means for receiving a mapping of the data radio bearer to at least one user radio bearer that interfaces between the relay and a user equipment (UE), wherein the mapping is based on a quality of service class identifier (QCI) associated with the data radio bearer.

24. The apparatus of claim 23, wherein the means for establishing comprises:
means for transmitting, to a relay mobility management entity, a create bearer request comprising an indication to not utilize TFTs for the data radio bearer.

25. The apparatus of claim 24, wherein the means for establishing further comprises:
means for receiving a bearer setup request comprising the QCI to be associated with the data radio bearer; and
means for transmitting, to the relay, a radio resource reconfiguration message comprising the QCI and the indication to not utilize TFT.

26. The apparatus of claim 24, wherein the indication comprises a TFT having an operation code value corresponding to “No TFT Operation”.

27. The apparatus of claim 23, wherein the QCI of the data radio bearer is designated for carrying the at least one user radio bearer.

28. The apparatus of claim 23, further comprising:
means for receiving at least one downlink packet to forward to the relay;
means for determining whether a service data flow (SDF) filter applies to the at least one downlink packet; and
means, responsive to determining the SDF filter does not apply, for utilizing the mapping to map the at least one downlink packet to the data radio bearer.

29. An apparatus for wireless communications, comprising:
means for establishing a data radio bearer that interfaces with a base station, in a manner that does not utilize traffic flow templates (TFTs) with the data radio bearer; and
means for receiving a mapping of the data radio bearer to at least one user radio bearer that interfaces between the apparatus and at least one user equipment (UE), wherein the mapping is based on a quality of service class identifier (QCI) associated with the data radio bearer.

30. The apparatus of claim 29, wherein the means for establishing comprises:
means for receiving a radio resource reconfiguration message comprising the QCI to be associated with the data radio bearer and an indication to not utilize TFTs for the data radio bearer.

31. The apparatus of claim 30, wherein the indication comprises a TFT having an operation code value corresponding to “No TFT Operation”.

32. The apparatus of claim 29, wherein the QCI of the data radio bearer is designated for carrying the at least one user radio bearer.

33. The apparatus of claim 29, further comprising:
means for receiving at least one uplink packet to forward to the base station;
means for determining whether a service data flow (SDF) filter applies to the at least one uplink packet; and
means, responsive to determining the SDF filter does not apply, for utilizing the mapping to map the at least one uplink packet to the data radio bearer.

34. A computer-program product comprising a computer-readable medium having instructions stored thereon, the instructions executable by one or more processors for establishing a data radio bearer that interfaces with a relay in a manner that does not utilize traffic flow templates (TFTs) with the data radio bearer; and
receiving a mapping of the data radio bearer to at least one user radio bearer that interfaces between the relay and a user equipment (UE), wherein the mapping is based on a quality of service class identifier (QCI) associated with the data radio bearer.

35. The computer-program product of claim 34, wherein the instructions for establishing comprises instructions for:
transmitting, to a relay mobility management entity, a create bearer request comprising an indication to not utilize TFTs for the data radio bearer.

36. The computer-program product of claim 35, wherein the instructions for establishing further comprises instructions for:
receiving a bearer setup request comprising the QCI to be associated with the data radio bearer; and
transmitting, to the relay, a radio resource reconfiguration message comprising the QCI and the indication to not utilize TFT.

37. The computer-program product of claim 35, wherein the indication comprises a TFT having an operation code value corresponding to “No TFT Operation”.

38. The computer-program product of claim 34, wherein the QCI of the data radio bearer is designated for carrying the at least one user radio bearer.

39. The computer-program product of claim 34, further comprising instructions for:
receiving at least one downlink packet to forward to the relay;
determining whether a service data flow (SDF) filter applies to the at least one downlink packet; and
responsive to determining the SDF filter does not apply, utilizing the mapping to map the at least one downlink packet to the data radio bearer.

40. A computer-program product comprising a computer-readable medium having instructions stored thereon, the instructions executable by one or more processors for:
establishing a data radio bearer that interfaces with a base station, in a manner that does not utilize traffic flow templates (TFTs) with the data radio bearer; and
receiving a mapping of the data radio bearer to at least one user radio bearer that interfaces between a relay and at least one user equipment (UE), wherein the mapping is based on a quality of service class identifier (QCI) associated with the data radio bearer.

41. The computer-program product of claim 40, wherein the instructions for establishing comprises instructions for:
receiving a radio resource reconfiguration message comprising the QCI to be associated with the data radio bearer and an indication to not utilize TFTs for the data radio bearer.

42. The computer-program product of claim 41, wherein the indication comprises a TFT having an operation code value corresponding to “No TFT Operation”.

43. The computer-program product of claim 40, wherein the QCI of the data radio bearer is designated for carrying the at least one user radio bearer.

44. The computer-program product of claim 40, further comprising instructions for:
receiving at least one uplink packet to forward to the base station;
determining whether a service data flow (SDF) filter applies to the at least one uplink packet; and
responsive to determining the SDF filter does not apply, utilizing the mapping to map the at least one uplink packet to the data radio bearer.
